(19) United States
(12) Patent Application Publication
(10) Pub. No.: US 2005/0274650 A1
(43) Pub. Date: Dec. 15, 2005

(54) Blood separation systems in micro device format and fabrication methods

(75) Inventors: A. Bruno Frazier, Mableton, GA (US); Ki Ho Han, Smyrna, GA (US)

Correspondence Address: Kenneth W. Float, 2095 Hwy. 211 NW, # 2F, Braselton, GA, 30517, US

(73) Assignee: Georgia Tech Research Corporation

(21) Appl. No.: 11/143,522

(22) Filed: Jun. 2, 2005

Related U.S. Application Data
(60) Provisional application No. 60/578,216, filed on Jun. 9, 2004.

(51) Int. Cl. B03C 1/30

(52) U.S. Cl. 209/39

(57) ABSTRACT

Single stage and cascaded stage magnetophoretic microseparators are disclosed that efficiently separate blood cells from whole blood based on their native magnetic properties using a high gradient magnetic field without the use of additives such as magnetic tagging or fluorescent dyes. The microseparators are fabricated using microfabrication methods, enabling integration of micro-scale magnetic flux concentrators in an aqueous microenvironment, providing strong magnetic forces, and fast separations.

### GOVERNMENT RIGHTS

The U.S. Government has a paid-up license in this invention and the right in limited circumstances to require the patent owner to license to others on reasonable terms as provided for by the terms of Contract Number 1 RO1 ES 10846-01 awarded by the National Institutes of Health and the National Institute for Environmental Health Sciences under Grant No. ES 10846.

### BACKGROUND

The present invention relates generally to blood separation systems and fabrication methods, and more particularly, to blood separation systems embodied in a micro device format and fabrication methods.

Much research has focused on developing magnetic separators based on a high gradient magnetic separation (HGMS) method because of its benefits, such as the capacity to produce a large separation force with simple device structures, ease of use, and the non-hydrolytic nature of magnetic fields. Such research is disclosed in the following papers: J. H. P. Watson, Journal of Applied Physics, 44, 4209, 1973; R. R. Birss, R. Gerber, and M. R. Parker, IEEE Transactions on Magnetics, MAG-12, 892, 1976; R. Gerber, IEEE Transactions on Magnetics, MAG-20, 1159, 1984; U.S. Pat. No. 6,688,473 issued to Franzreb et al.; D. Melville, F. Paul, and S. Roath, Nature, 255, 706, 1975; C. Delatour, G. Schmitz, E. Maxwell D. Kelland, IEEE Transactions on Magnetics, MAG-19, 2127, 1983; R. S. Molday, S. P. Yen and A. Rembaum, Nature, 268, 437 (1977); and M. Zborowski, L. Sun, L. R. Moore, S. Williams and J. J. Chalmers, Journal of Magnetism and Magnetic Materials, 194, 224, 1999.

The HGMS method disclosed in the Watson and Birss papers uses a high gradient magnetic field to separate paramagnetic and diamagnetic particles from a fluid, such as water, soil, or air. Conventional magnetophoretic macroseparators, such as is disclosed in the Gerber paper and U.S. Pat. No. 6,688,473, have been used for separation of ultra-fine magnetic particles, heavy metals, slurry formed radioactive waste, and for water purification. Additional research has shown that magnetophoretic macroseparators using the HGMS method can be used to separate bio-components based on magnetic beads or based on their native magnetic properties. This is disclosed by D. Melville, F. Paul, and S. Roath, Nature, 255, 706 (1975), D, Melville, F. Paul, and S. Roath, IEEE Transactions on Magnetics, MAG-18, 1680, 1982, and M. Takayasu, D. R. Kelland, and J. V. Minervini, IEEE Transactions on Applied Superconductivity, 10, 927, 2000.

Unfortunately, the difference in magnetic properties of native biological particles usually is not large or specific enough to separate subpopulations (see D. Recktenwald, A. Radbruch, Ed. Cell Separation Methods and Applications; Marcel Dekker, Inc.: New York, 1998). Thus, magnetic cell separation (MACS) using magnetic beads has become the most common method used for separating biological cells. The main advantage of MACS that is based on magnetic beads is that it can be used for performing high quality separations of a wide range of cells, including rare cell types. However, this type of MACS has several disadvantages. For example, MACS based on magnetic beads is a discontinuous separation method, requires expensive magnetic beads, uses a magnetic shear force that may cause retained cells to become nonviable, and requires additional steps for sample preparation before and after sorting.

Furthermore, much research, with a focus on the native magnetic properties of biological cells, has reported that the deoxyhemoglobin red blood cells in whole blood are paramagnetic particles. This is discussed in D. S. Taylor, and C. D. Coryell, The magnetic susceptibility of the iron in ferrohemoglobin, Journal of the American Chemical Society, 60, 1177-1181, 1938; D. Melville, F. Paul, and S. Roath, Direct magnetic separation of red cells from whole blood, Nature, 255, 706, 1975; D. Melville, F. Paul, and S. Roath, High gradient magnetic separation of red cells from whole blood, IEEE Transactions on Magnetics, MAG-11, 1701-1704, 1975; D. Melville, F. Paul, and S. Roath, Fractionation of blood components using high gradient magnetic separation, IEEE Transactions on Magnetics, MAG-18, 1680-1685, 1982; M. D. Graham, Efficiency comparison of two preparative mechanisms for magnetic separation of erythrocytes from whole blood, Journal of Applied Physics, 52, 2578-2580, 1981; A. S. Bahaj, J. H. P. Watson, and D. C. Ellwood, Determination of magnetic susceptibility of loaded micro-organisms in bio-magnetic separation, IEEE Transactions on Magnetics, 25, 3809-3811, 1989; J. Svoboda, Separation of red blood cells by magnetic means, Journal of Magnetism and Magnetic Materials, 220, L103-L105, 2000; M. Okazaki, K. Kon, N. Maeda, and T. Shiga, Distribution of erythrocyte in a model vessel exposed to inhomogeneous magnetic fields, Physiological Chemistry and Physics and Medical NMR, 20, 3-14, 1988; and M. Zborowski, G. R. Ostera, L. R. Moore, S. Milliron, J. J. Chalmers, and A. N. Schechter, Red blood cell magnetophoresis, Biophysical Journal, 84, 2638-2645, 2003.

According to the literature, the relative magnetic susceptibility of the deoxyhemoglobin red blood cells in water (or plasma) is about 3.9×10⁻⁶ (SI), which is much larger than that of other biological cells, and the native magnetic properties of white blood cells are rarely reported. The reasons for this are that white blood cells have a relatively lower magnetic susceptibility than red blood cells, the magnetic susceptibility of white blood cells decreases with time, and there are five types of white blood cells. Takayasu et al. reported that white blood cells behave like diamagnetic particles in water (M. Takayasu, N. Duske, S. R. Ash, and F. J. Friedlaender, HGMS studies of blood cell behavior in plasma, IEEE Transactions on Magnetics, MAG-18, 1520-1522, 1982; and M. Takayasu, D. R. Kelland, and J. V. Minervini, Continuous magnetic separation of blood components from whole blood, IEEE Transactions on Applied Superconductivity, 10, 927-930, 2000.

Based on the inherent magnetic properties of blood cells, some research cited above has focused on developing cell separators that use the HGMS method, which can avoid the disadvantages of MACS using magnetic beads. However, conventional macro scale magnetophoretic separators, characterized by centimeter to millimeter scale dimensions, have the capability to generate relatively small magnetic flux gradients on biological cells. This fact, combined with the inherently small magnetic susceptibilities of blood cells, has led to limited success with macro scale systems.

To overcome the low magnetic forces on bio-components, and to take advantage of the geometrical scaling advantages of miniaturization, microfabrication technology can be used to fabricate a magnetophoretic separator with micro-scale dimensions and relatively large magnetic flux gradients. It would be desirable to have a continuous magnetophoretic microseparator fabricated by microfabrication technology for separating white and red blood cells from whole blood based on their native magnetic properties.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates a cylindrical coordinates of a magnetic particle with respect to a circular ferromagnetic wire in a uniform external magnetic flux;

FIG. 2 shows the direction of the magnetic force around a circular ferromagnetic wire within a uniform external magnetic flux;

FIGS. 3a and 3b are perspective and cross-sectional views of exemplary magnetophoretic microseparators having one inlet and three outlets using diamagnetic capture mode;

FIGS. 3c is a schematic of an exemplary magnetophoretic microseparator using paramagnetic capture mode;

FIGS. 3d-3g illustrate top views of additional embodiments of single stage magnetophoretic microseparators;

FIGS. 4a and 4b illustrates an exemplary cascaded continuous paramagnetic capture mode magnetophoretic microseparator.

FIGS. 4c and 4d illustrate top views of additional embodiments of cascaded magnetophoretic microseparators;

FIG. 5 illustrates a simulated distribution of magnetic flux around a ferromagnetic wire in a uniform external magnetic flux;

FIGS. 6a and 6b are graphs that show comparisons between calculated and simulated y-direction magnetic force on a red blood cell for varying distance from the wire shown in FIG. 2;

FIGS. 7a-7d illustrates an exemplary microfabrication process for the magnetophoretic microseparators;

FIG. 8 is a chart showing the measured and estimated relative separation percentage of red blood cells at each outlet of the DMC microseparator for various average flow velocities;

FIG. 9 is a chart showing the measured and estimated relative separation percentage of red blood cells at each outlet of the DMC microseparator for various average flow velocities;

FIG. 10 is a chart showing the measured and estimated relative separation percentage of white blood cells at each outlet of the DMC microseparator for various average flow velocities;

FIG. 11 is a chart showing the measured relative separation percentage of breast cancer cells at each outlet of the DMC microseparator at 0.05 mm/sec average flow velocity; and

FIG. 12 is a chart showing the measured relative separation percentage of breast cancer cells at each outlet of the PMC microseparator at 0.05 mm/sec average flow velocity.

### DETAILED DESCRIPTION

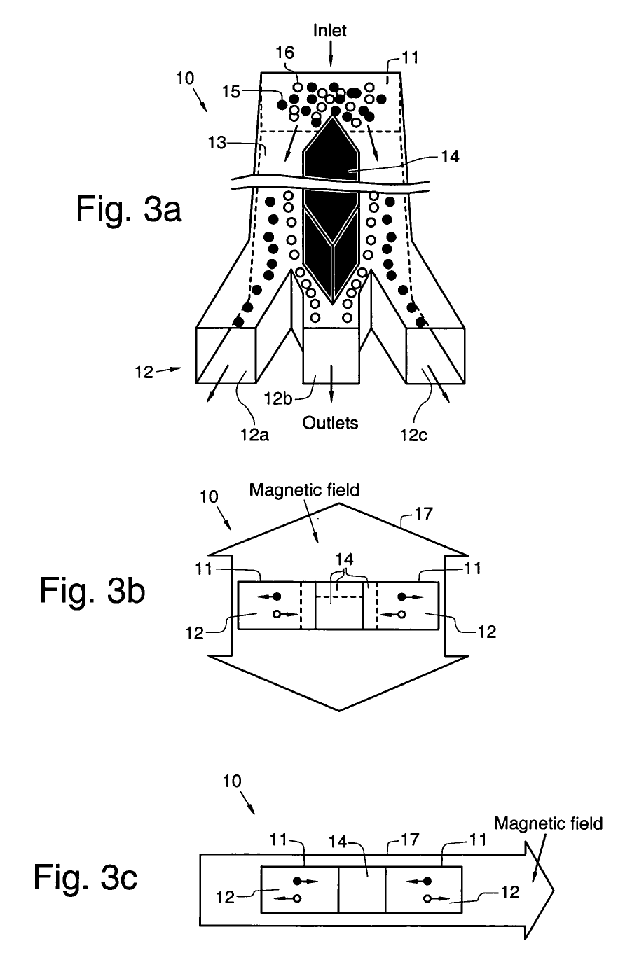

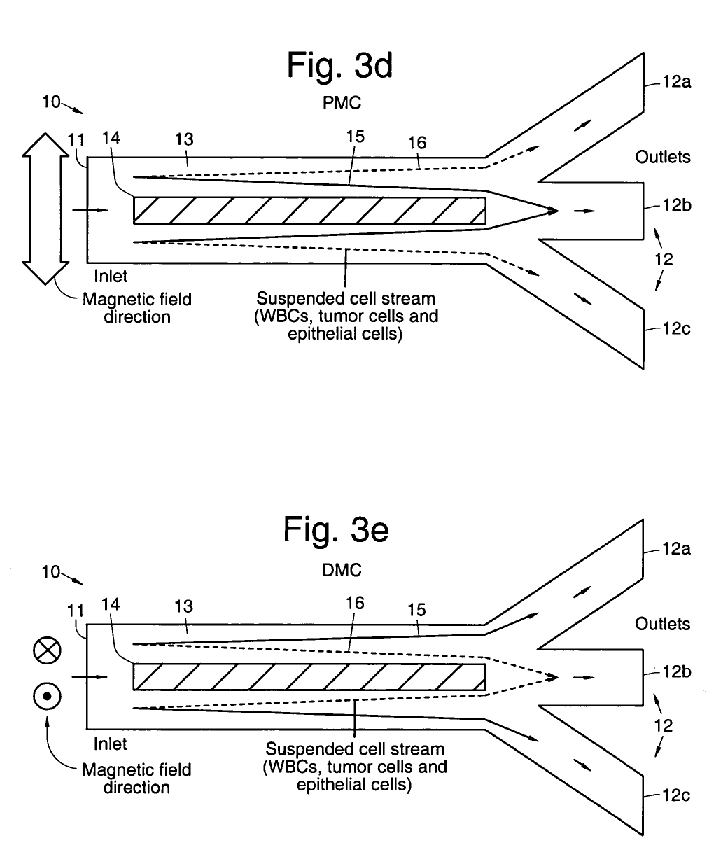

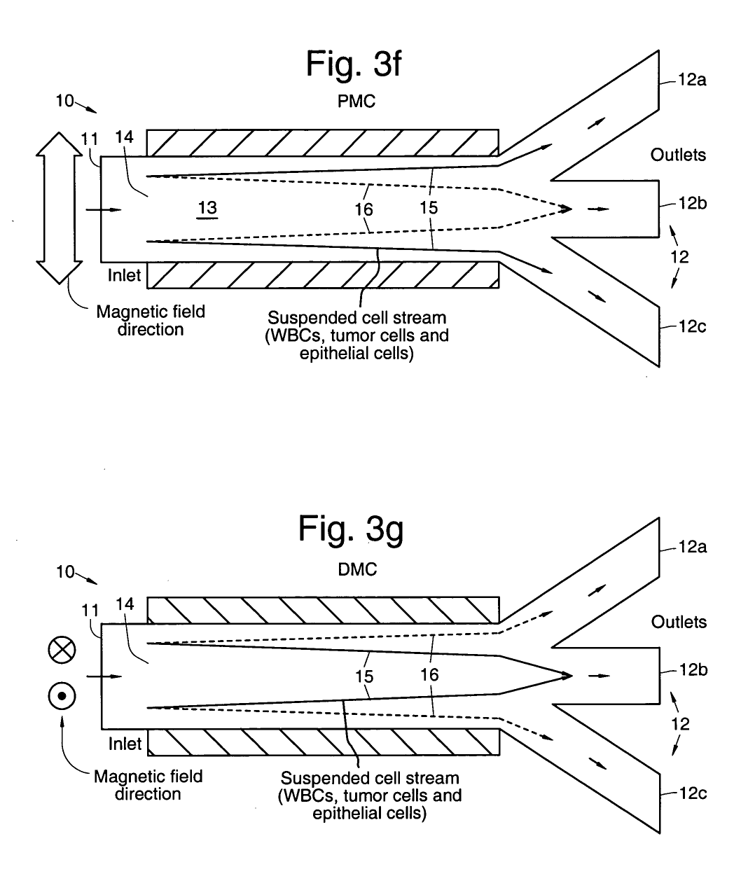

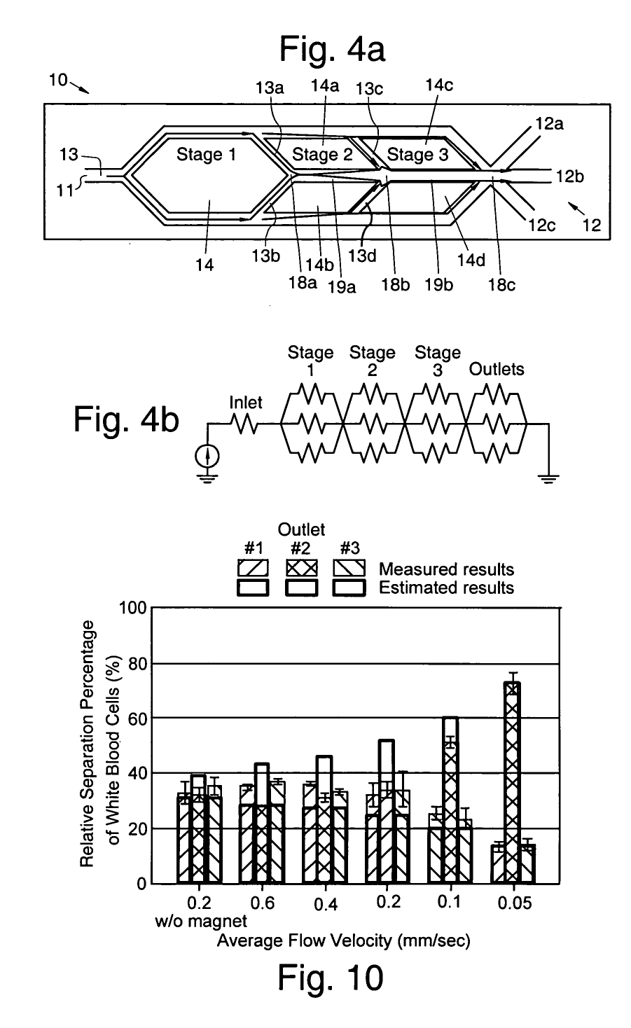

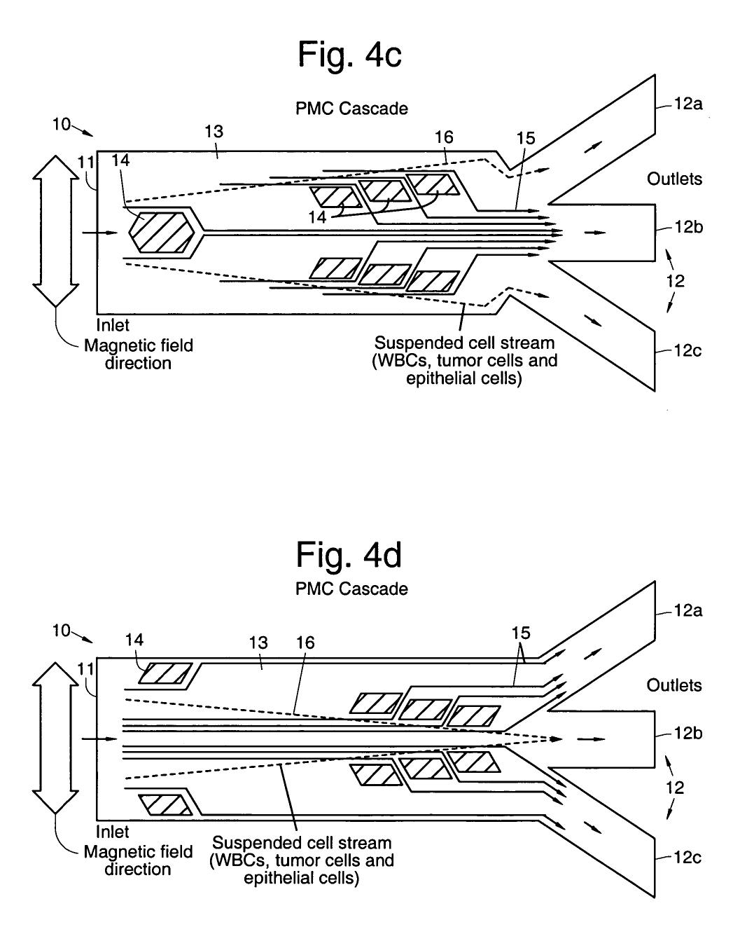

Referring to the drawing figures, disclosed are continuous magnetophoretic microseparators 10 (see FIGS. 3a-3g, and 4a-4d) for separating suspended cells including white and red blood cells from whole blood by using a high gradient magnetic separation method and microfabrication technology. The magnetophoretic microseparators 10 directly separate suspended cells from blood based on their native magnetic properties without the use of additives such as magnetic tagging or inducing materials. The magnetophoretic microseparators 10 may be used in both diamagnetic capture mode (DMC) and paramagnetic capture mode (PMC). As will be discussed below, the microseparators 10 are fabricated using microfabrication technology, enabling integration of micro-scale magnetic flux concentrators in an aqueous microenvironment, to provide strong magnetic forces, and fast separations.

Experimental results relating to reduced to practice embodiments of the microseparator 10 show that a diamagnetic capture mode microseparator 10 can continuously separate out 89.7% of red blood cells and 72.7% of white blood cells, and a three-stage cascade paramagnetic capture mode microseparator 10 (FIG. 4a) can continuously separate out 93.5% of red blood cells and 97.4% of white blood cells from whole blood by applying an external magnetic flux of 0.2 T using a permanent magnet.

A theoretical model of the magnetophoretic microseparator 10 is derived and is compared with finite element simulation later in this description.

As is disclosed by D. S. Taylor, and C. A. Coryell, Journal of the American Chemical Society, 60, 1177, 1938, blood cells can be considered as small magnetic particles. In whole blood, the white blood cells are diamagnetic and the deoxyhemoglobin red blood cells are paramagnetic

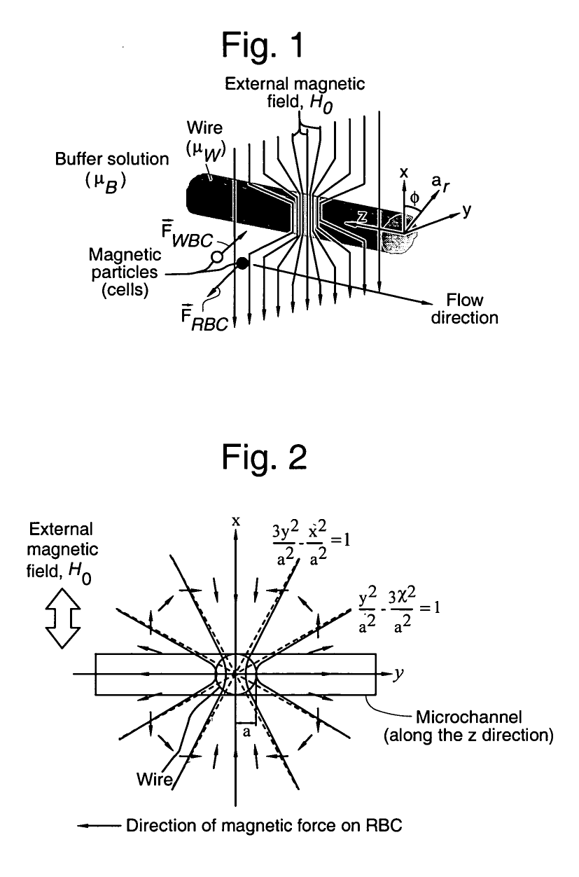

The magnetophoretic microseparators 10 use a high gradient magnetic field created by incorporating a small ferromagnetic wire 11 along the length of a micro fluidic channel 12, which is subsequently placed in a uniform external magnetic field (FIG. 1).

Consider a ferromagnetic wire 11 of radius a and placed axially along the z-axis, as shown in FIG. 1, with magnetic particles flowing parallel to the wire. A uniform external magnetic field, H₀, is applied normal to the axis of the wire. In free space, the magnetostatic conditions can be expressed as:
∇·\overline{B}=0 (1a)
∇×\overline{H}=0 (1b)
where B and H are the magnetic flux and the magnetic field, respectively.

The non-rotational nature of the magnetic field, H, indicated by Eq. (1b) allows the definition of a scalar magnetic potential, V, as:
\overline{H}=−∇V (2)

From Eqs. (1b) and (2), we can obtain Laplace's equation of V, as:
∇²V=0 (3)

A general solution of z-independent Laplace's equation for circular cylindrical regions with an unrestricted range for angle, φ, can be expressed as:
Vₙ=rⁿ[αₙ sin(nφ)+βₙ cos(nφ)]+r⁻ⁿ[α′ₙ sin(nφ)+β′ₙ cos(nφ)] (4)
where r and ö are the cylindrical coordinates of the distance and angle, αₙ, βₙ, α′ₙ and β′ₙ are arbitrary constants, and n is a positive integer.

It is useful to note that, when the region of interest lies on the cylindrical axis where r=0, the terms containing the r⁻ⁿ factor cannot exist. On the other hand, if the region of interest includes a point at infinity, the terms containing the rⁿ factor cannot exist except for n=1, since the magnetic field, H, must be H₀ as r→∞. Under these two conditions, Eq. (4) can be rewritten as:

Vₙ=rⁿ[αₙ sin(nφ)+β′₁ cos(nφ)], r<a (5a)
Vₙ=r[α′₁ sin(φ+β′₁ cos(φ)]+r⁻ⁿ[α″ₙ sin(nφ)+β″ₙ cos(nφ)], r>a (5b)
where α″ₙ and β″ₙ are arbitrary constants.

For a cylindrical wire, the magnetic potential will produce a non-zero gradient along the x-axis and a zero gradient along the y-axis. Therefore, in both Eqs. (5a) and (5b) sin nφ term cannot exist, and n=1. Equations (5a) and (5b) can then be expressed as:
V=β₁ cosφ, r<a (6a)

$$V = r {β}_{1}^{′} cos φ + \frac{1}{r} {β}_{1}^{″} cos φ , r > a \qquad ( 6 b )$$

Using a boundary condition that the magnetic field, \overline{H}, as r→∞ is H₀\overline{a}ₓ, yields:
β′₁=−H₀ (7)

To obtain β₁ and β″₁, boundary conditions for a magnetostatic field at r=a are used as:
Bₙ|_{r→a-0}=Bₙ|_{r→a+0} (8a)
Hₜ|_{r→a-0}=Hₜ|_{r→a+0} (8b)
where Bₙ|_{r→a-0} and Hₜ|_{r→a-0} are the normal component of the magnetic flux and the tangential component of the magnetic field from the wire interface(r=a−0), and Bₙ|_{r→a+0} and Hₜ|_{r→a+0} are the normal component of the magnetic flux and the tangential component of the magnetic field from the buffer solution interface(r=a+0), respectively. By substituting Eqs. (2), (6a) and (6b) into Eqs. (8a) and (8b), β₁ and β″₁ can be calculated as:

$$\begin{matrix}{β}_{1} = \frac{- 2 {i}_{B} {H}_{0}}{{i}_{W} + {i}_{B}} & ( 9 ) \\ {β}_{1}^{″} = {ka}^{2} {H}_{0} ( k = \frac{{i}_{W} - {i}_{B}}{{i}_{W} + {i}_{B}} ) where & ( 10 ) \\ k = \frac{{μ}_{w} - {μ}_{B}}{{μ}_{w} + {μ}_{B}} & ( 11 )\end{matrix}$$

where i_{B} and i_{W} are the permeabilities of the buffer solution and the ferromagnetic wire, respectively.

By using Eqs. (7), (9) and (10), Eqs. (6a) and (6b) can be expressed as:

$$\begin{matrix}V = - r \frac{2 {i}_{B} {H}_{0}}{{i}_{W} + {i}_{B}} cos φ , r < a & ( 12 a ) \\ V = \underbrace{- {rH}_{0} cos φ}_{\begin{matrix}Affected by the \\ external magnetic \\ field\end{matrix}} + \underbrace{\frac{1}{r} {ka}^{2} {H}_{0} cos φ}_{\begin{matrix}Affected by the \\ ferramagnetic wire\end{matrix}} , r > a & ( 12 b )\end{matrix}$$

The magnetic force, \overline{F}_{BC}, on a blood cell placed in the buffer solution can be calculated as:

$${\overline{F}}_{BC} = \frac{1}{2} {μ}_{0} \underbrace{( {χ}_{BC} - {χ}_{B} )}_{= χ} {V}_{BC} ∇ ( \overline{H} ∘ \overline{H} ) \qquad ( 13 )$$

where χ_{BC} and χ_{B} are the susceptibilities of the blood cell and the buffer solution, respectively, and V_{BC} is the volume(=4/3·π b³) of a blood cell of radius b.

Substituting Eqs. (2) and (12b) into Eq. (13), the magnetic force on a blood cell is:

$${\overline{F}}_{BC} = - \frac{2 k {?}_{0} χ {V}_{BC} {a}^{2}}{{r}^{3}} ( k \frac{{a}^{2}}{{r}^{2}} + cos 2 φ ) {H}_{0}^{2} {\overline{a}}_{r} - \\ \frac{2 k {?}_{0} χ {V}_{BC} {a}^{2}}{{r}^{3}} {H}_{0}^{2} sin 2 φ {\overline{a}}_{φ} , r > a \qquad ( 14 )$$

From Eq. (12a), the magnetic field, H_{W}, induced in a circular ferromagnetic wire can be shown to be

$${\overline{H}}_{W} = - ∇ V = \frac{2 {μ}_{B} {H}_{0}}{{μ}_{W} + {μ}_{B}} {\overline{a}}_{x} , r < a \qquad ( 15 )$$

where the \overline{a}ₓ is unit vector for the x-direction (FIG. 1) in the Cartesian coordinate.

According to Eq. (15), if a circular ferromagnetic wire is not magnetically saturated (i.e., i_{W}>>μ_{B}), the magnitude of the magnetic flux, B_{W}(=μ_{W}H_{W}), induced in the circular ferromagnetic wire is approximately two times the applied uniform external magnetic flux, B₀(=μ₀H₀), in case of μ_{B}≈μ₀. Therefore, criteria for determining the magnetic saturation of the circular wire, based on the saturation magnetization, M_{S}, of the wire, and the external magnetic flux, B₀, can be formulated. That is, for 2B₀≦μ₀M_{S}(=B_{S}), the circular wire is magnetically non-saturated, while for 2B₀>μ₀M_{S}, the wire is magnetically saturated. If the wire is magnetically non-saturated (i.e. i_{W>>μ}_{B}), k is 1. On the other hand, if the wire is magnetically saturated and μ_{B}=μ₀, then (μ_{W}−μ_{B})H_{W}=μ₀χ_{W}H_{W}=μ₀M_{S}. Furthermore, by substituting the former equation and Eq. (15) into Eq. (11), it can be shown that k becomes equal to M_{S}/2H₀. As a result, the criteria related to the magnetic saturation of the circular wire and the value of k are summarized as
k=1, 2B₀≦μ₀M_{S} (i.e., magnetic non-saturation) (16a)

$$k = \frac{{M}_{S}}{2 {H}_{0}} , 2 {B}_{0} > {μ}_{0} {M}_{S} \text{(i.e., magnetic saturation)} \qquad ( 16 b )$$

Substituting Eqs. (2), (12a), (12b) (16a) and (16b) into Eq. (13), the magnetic force on a blood cell is:

$$\begin{matrix}{\overline{F}}_{BC} = - \frac{2 {?}_{0} Δ χ {V}_{BC} {a}^{2}}{{r}^{3}} ( \frac{{a}^{2}}{{r}^{2}} + cos 2 φ ) {H}_{0}^{2} {\overline{a}}_{r} - & ( 17 a ) \\ \frac{2 {?}_{0} Δ χ {V}_{BC} {a}^{2}}{{r}^{3}} sin 2 φ {H}_{0}^{2} {\overline{a}}_{?} , r > a and 2 {B}_{0} \leq {μ}_{0} {M}_{S} & \\ {\overline{F}}_{BC} = - \frac{{μ}_{0} Δ χ {V}_{BC} {M}_{S} {a}^{2}}{{r}^{3}} ( \frac{{M}_{S}}{2} \frac{{a}^{2}}{{r}^{2}} + {H}_{0} cos 2 φ ) {\overline{a}}_{r} - & ( 17 b ) \\ \frac{{μ}_{0} Δ χ {V}_{BC} {M}_{S} {a}^{2}}{{r}^{3}} sin 2 φ {H}_{0} {\overline{a}}_{φ} , r > a and 2 {B}_{0} > {μ}_{0} {M}_{S} & \end{matrix}$$

where Δ_{χ}(=χ_{BC}−χ_{B}) is the relative magnetic susceptibility of a blood cell to the buffer solution, and \overline{a}ᵣ and \overline{a}_{φ} are unit vectors for the distance and angle in the cylindrical coordinate.

From Eqs. (17a) and (17b), for magnetic particles placed on the x-axis (φ≈0° in FIG. 1), sin 2φ=0, cos2φ≈1, and the wire attracts particles for which is positive (i.e., paramagnetic particles). For magnetic particles placed on the y-axis (φ≈90° in FIG. 1), sin 2φ≈0, cos2φ≈−1, and the wire attracts particles for which χ is negative (i.e., diamagnetic particles). The first geometric configuration has been called the paramagnetic capture mode; the latter has been called the diamagnetic capture mode (see M. Takayasu, D. R. Kelland, and J. V. Minervini, IEEE Transactions on Applied Superconductivity, 10, 927, 2000). Using the diamagnetic capture mode, the magnetic poles can be placed in close proximity to create a strong external magnetic field. To achieve a high magnetic force (proportional to the square of external magnetic field as given by Eq. (17a)), the magnetophoretic microseparator 10 is designed to use the diamagnetic capture mode. From the derived theoretical model of the magnetophoretic microseparator 10, the direction of the magnetic force around a circular ferromagnetic wire, within a uniform external magnetic field, H₀, can be estimated (FIG. 2). FIG. 2 shows that the diamagnetic capture mode can be realized by placing the microchannel along the z-axis, normal to the external magnetic field.

FIG. 3a shows a schematic of an exemplary magnetophoretic microseparator 10. The exemplary magnetophoretic microseparator 10 shown in FIG. 3a is designed for use in diamagnetic capture mode. The magnetophoretic microseparator 10 comprises a microchannel 13 having one inlet channel 11 and three outlet channels 12, comprising left, center and right laterally separated outlet channels 12a, 12b, 12c, from left to right. However, it is to be understood that there may be a plurality of inlet channels 11 and a plurality of (i.e., less than three) outlet channels 12. Therefore, the microseparator 10 is not required to have one inlet and three outlet channels 12.

A ferromagnetic wire 14 is disposed along the length of the microchannel 13. When an external magnetic field 17 (FIG. 3b) is applied normal to the microchannel 13, i.e., normal to the axis of a ferromagnetic wire 14, it is deformed near the ferromagnetic wire 14, and generates a high gradient magnetic field. Blood cells 15, 16 (red 15, white 16) flowing parallel to the ferromagnetic wire 14 experience a magnetic force by the high gradient magnetic field created near the ferromagnetic wire 14.

FIG. 3b also shows that the ferromagnetic wire 14 may have differing cross sections. These cross sections may be square, rectangular, or circular, for example. Furthermore, the ferromagnetic wire 14 may be made of any ferromagnetic material such as nickel, nickel.-iron or a nickel-cobalt alloy, for example.

Red blood cells 15 are forced away from the ferromagnetic wire 14 and suspended cells 16 in blood, such as white blood cells, tumor cells and epithelial cells, for example, are drawn closer to the ferromagnetic wire 14, as is shown in FIG. 3b. Therefore, the blood cells (and suspended cells) 15, 16 are separated continuously as the whole blood passes through the microchannel 13 of the magnetophoretic microseparator 10. The red blood cells 15 are forced into the left and right outlet channels 12a, 12c, and the suspended cells 16 are forced into the center outlet channel 12b.

For a diamagnetic capture mode magnetophoretic microseparator 10, an external magnetic field is applied normal to the microchannel 13 in the x-direction, as shown in FIG. 3a. Then, the red blood cells 15 as paramagnetic particles are forced away from the ferromagnetic wire and the suspended cells 16 as diamagnetic particles are drawn closer. Thus, the red blood cells 15 are separated continuously into the left and right outlet channels 12a, 12c, and the suspended cells are separated continuously into the center outlet channel 12b.

FIG. 3c is a schematic of an exemplary magnetophoretic microseparator 10 using paramagnetic capture mode. It is constructed in a similar manner as the microseparator 10 described with reference to FIGS. 3a and 3b, except that the magnetic field is applied in a direction normal to the microchannel 13 in a plane defining the microchannel 13.

For a paramagnetic capture mode magnetophoretic microseparator 10, an external magnetic field is applied normal to the microchannel 13 in the y-direction, as shown in FIG. 3c. Then, the red blood cells 15 are drawn closer to the ferromagnetic wire 14 and suspended cells 16, such as white blood cells, tumor cells and epithelial cells, for example, are forced away from the ferromagnetic wire 14. Therefore, the red blood cells 15 are separated continuously into the center outlet channel 12b, and the suspended cells 16 are separated continuously into the left and right outlet channels 12a, 12c.

From Stokes' law for viscous drag, the y-direction velocity, v_{BC}, of the blood cells 15, 16 forced by the magnetic flux gradient can be expressed as:

$${v}_{BC} = \frac{{F}_{BC} {\vert}_{φ = 90 °}}{6 π η b} \qquad ( 18 )$$

where η is the apparent viscosity of the blood cell in a buffer solution.

From Eqs. (14) and (18), the time required for a blood cell 15, 16 to move from position r₁ to position r₂ (i.e., trapping time) on the y-axis in FIG. 2 can be calculated as:

$$t = \frac{9 ?}{16 k {μ}_{0} χ {a}^{2} {b}^{2} {H}_{0}^{2}} [ ( {r}_{2}^{4} - {r}_{1}^{4} ) + 2 {ka}^{2} ( {r}_{2}^{2} - {r}_{1}^{2} ) + \\ 4 {k}^{2} {a}^{4} ln \sqrt{\frac{{r}_{2}^{2} - {ka}^{2}}{{r}_{1}^{2} - {ka}^{2}}} ] \qquad ( 19 )$$

where r₁ and r₂ are arbitrary positions of the blood cell 15, 16 on the y-axis, and r₂≧r₁.

One embodiment of the magnetophoretic microseparator 10 was designed for trapping times less than 5 min for r₁=a+b and r₂=a+50 μm. Using this criterion and the related flow velocity about 0.1 mm/sec, the microchannel length and width were designed as 30 mm and 200 μm, respectively.

Another embodiment of the microseparator 10 was designed for trapping times less than 10 minutes. By this criterion, the microchannel length and width are determined. Table 1 summarizes the characteristics of this magnetophoretic microseparator 10.

TABLE 1
Characteristics of the magnetophoretic microseparator 10.

| Characteristic | Value | |
|---|---|---|
| Channel width | 150 | [μm] |
| Channel length | 30 | [mm] |
| Maximum tapping time | 5 | [min] |
| Minimum flow velocity* | 0.2 | [mm/sec] |

*Flow rate = 0.12 ml/h

FIGS. 3d-3g illustrate top views of additional single stage magnetophoretic microseparators 10. FIGS. 3d-3g illustrate that the paths designated by the dashed lines represent a suspended cell stream which may include white blood cells, tumor cells or epithelial cells, for example.

FIGS. 4a and 4b illustrate an exemplary cascaded continuous paramagnetic capture mode magnetophoretic microseparator 10. As shown in FIG. 4a, the paramagnetic capture mode cascade microseparator 10 is comprised of three separation stages (Stage 1, Stage 2, Stage 3) from left to right, and two drain channels 19a, 19b for sinking red blood cell accumulation at edges of wires 14. The microseparator 10 includes ferromagnetic wires 14, incorporated along the length of the microchannel 13 to form the three separation stages (Stage 1, Stage 2, Stage 3), and has three outlet channels 12a, 12b, 12c, from bottom to top.

More particularly, the first blood separation stage (Stage 1) is formed in the manner discussed with regard to FIG. 3a. The first blood separation stage comprises a ferromagnetic wire 14 disposed in a microchannel 13 that is separated from lateral walls of the microchannel 13 and around which whole blood can flow.

The second blood separation stage (Stage 2) is disposed between the ferromagnetic wire 14 and the outlet channels 12a, 12b, 12c. The second blood separation stage comprises a second ferromagnetic wire structure having left and right ferromagnetic wire portions 14a, 14b that are separated from the ferromagnetic wire to define left and right blood flow channels 13a, 13b therebetween. The left and right ferromagnetic wire portions 14a, 14b are separated from lateral walls of the microchannel 13, and are separated from each other to define a first drain channel 19a therebetween.

The third blood separation stage (Stage 3) is disposed between the second blood separation stage (Stage 2) and the outlet channels 12a, 12b, 12c. The third blood separation stage comprises a third ferromagnetic wire structure having left and right ferromagnetic wire portions 14c, 14e that are separated from the left and right ferromagnetic wire portions 14a, 14b of the second ferromagnetic wire structure to define left and right blood flow channels 13c, 13d therebetween. The left and right ferromagnetic wire portions 14c, 14d are separated from the lateral walls of the microchannel, and are separated from each other to define a second drain channel 19b therebetween As the whole blood passes through the microchannel 13 of the paramagnetic capture mode cascade microseparator 10, red blood cells 15 are separated at a first separation location 18a between Stage 1 and Stage 2, and flow into a first drain channel 19a. Residual red blood cells 15, which do not flow into the first drain channel 19a, are separated again at a second separation location 18b between Stage 2 and Stage 3, and flow into a second drain channel 19b. The red blood cell's 15 from the first drain channel 19a continuously flow into the second drain channel 19b. Lastly, red blood cells 15 are separated again at a third separation location 18c between the third stage (Stage 3) and the outlet channels 12a, 12b, 12c, and red blood cells 15 from the second drain channel 19b flow into the outlet channels 12a, 12b, 12c. The arrowed lines in FIG. 4a show the conceptual flowing path of red blood cells 15 passing through the microchannel 13 of the paramagnetic capture mode cascade microseparator 10 with application of the external magnetic field. Simultaneously, suspended cells 16, such as white blood cells, tumor cells and epithelial cells, for example, are forced away from ferromagnetic wire 14 at all the separation stages, and therefore the suspended cells 16 flow out into the first and third outlet channels 12a, 12c. FIG. 4b shows an equivalent circuit model for the microfluidic flow of the three-stage paramagnetic capture mode cascade microseparator 10 shown in FIG. 4a.

FIGS. 4c and 4d illustrate top views of additional embodiments of cascaded magnetophoretic microseparators 10. FIGS. 4c and 4d also illustrate that the paths designated by the dashed lines represent a suspended cell stream which may include white blood cells, tumor cells or epithelial cells, for example.

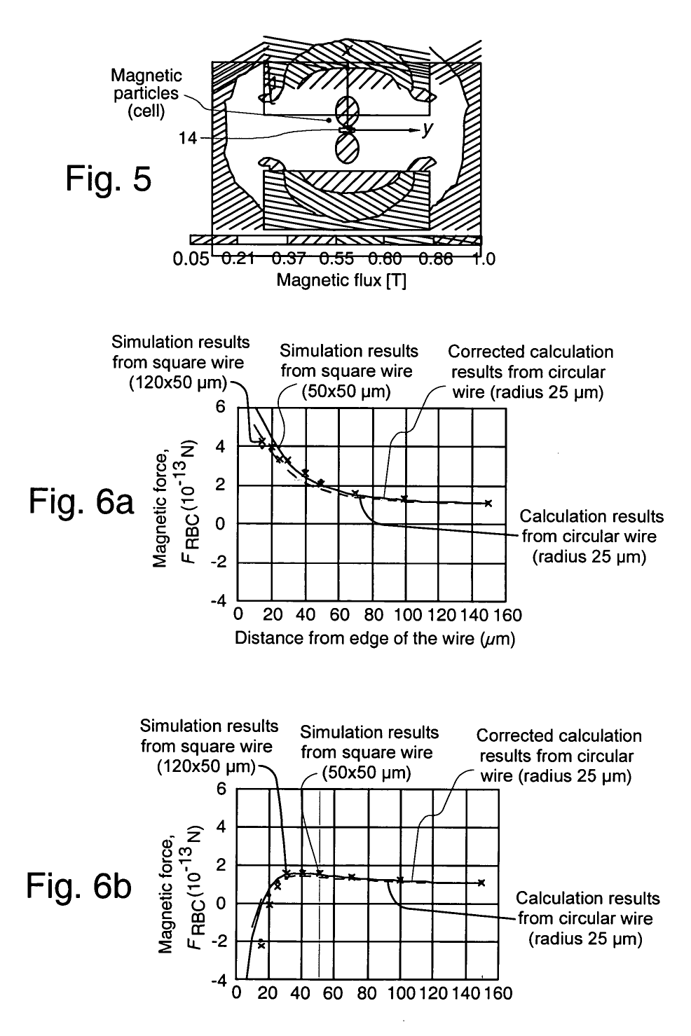

A finite element program, ANSYS (ANSYS, Inc., Canonsburg, Pa.), was used to simulate the magnetic force on a red blood cell 15, 16. FIG. 5 shows the simulated distribution of the magnetic flux around a square ferromagnetic wire 14 in a uniform external magnetic flux. It shows that the magnetic flux density increases with increasing distance from the wire 14 along the y-axis; therefore the red blood cell 15, 16 is forced away from the wire 14.

For analytic calculations and simulations, the magnetic susceptibilities, χ_{RBC}=−3.8×10⁻⁶ for deoxygenated red blood cells 15, 16, and χ_{B}=−7.7×10⁻⁶ for the buffer solution were used. The external magnetic flux, B₀=μ_{B}H₀, and the saturated magnetic flux, M_{S}=i_{W}H₀, of the ferromagnetic wire were 0.2 T and 0.6 T, respectively.

FIGS. 6a and 6b show a comparison between the calculated and simulated y-directional magnetic forces on red blood cells 15 along x=0 and x=−23 μm (FIG. 1), respectively. FIGS. 6a and 6b indicate that the magnetic force is much different as blood cells 15, 16 are placed at a different height within the microchannel 13. As can be seen in FIG. 6a, when the red blood cells 15 are placed closer than 22 μm from the edge of the wire along x=−23 μm, the red blood cells 15 are forced towards the wire. This is one drawback of the DMC microseparator 10, inherently decreasing the separation efficiency. Although a circular ferromagnetic wire 14 was used for the theoretical analysis, a square wire 14 was used for the simulation. In practice, the cross-section of the ferromagnetic wire 14 is restricted to a square shape by microfabrication process limitations. As shown in FIGS. 6a and 6b, the calculation magnetic force on red blood cells 15 from a circular wire 14 of 25 μm radius is slightly smaller than the simulation magnetic force from a square wire 14 of 50×50 μm². Formulas to calculate the magnetic force from a square wire 14 could not be derived. However, the magnetic force from the square wire 14 can be estimated conceptually using Eq. (15). That is, the magnetic field has the intrinsic property that it travels the path with the lowest magnetic reluctance. Therefore, more of the external magnetic field will pass through the square wire 14 relative to the circular wire 14, thereby resulting in a larger magnetic field gradient around the square wire 14. For red blood cells 15 placed at same distance from the center of the ferromagnetic wire 14, the magnetic force from the square wire 14 will be slightly larger than that from the circular wire 14. To compensate for the difference, a correction factor of 4/π can be used, which is ratio of cross-section area between the square and circular wires 14. Thus, the calculated magnetic force from the circular wire 14 was multiplied by the correction factor to estimate the magnetic force of the square wire 14. FIGS. 6a and 6b show that the corrected calculated magnetic force from the circular wire 14 having a 25 μm in radius agrees well with the simulation magnetic force from the square wire 14 that is 50×50 μm². Consequently, if the diameter of the circular wire 14 is same length of a side of a square wire 14, the magnetic force of the square wire 14 is more accurately obtained from the Eq. (17a) for the magnetic force of the circular wire multiplied by the correction factor of 4/π.

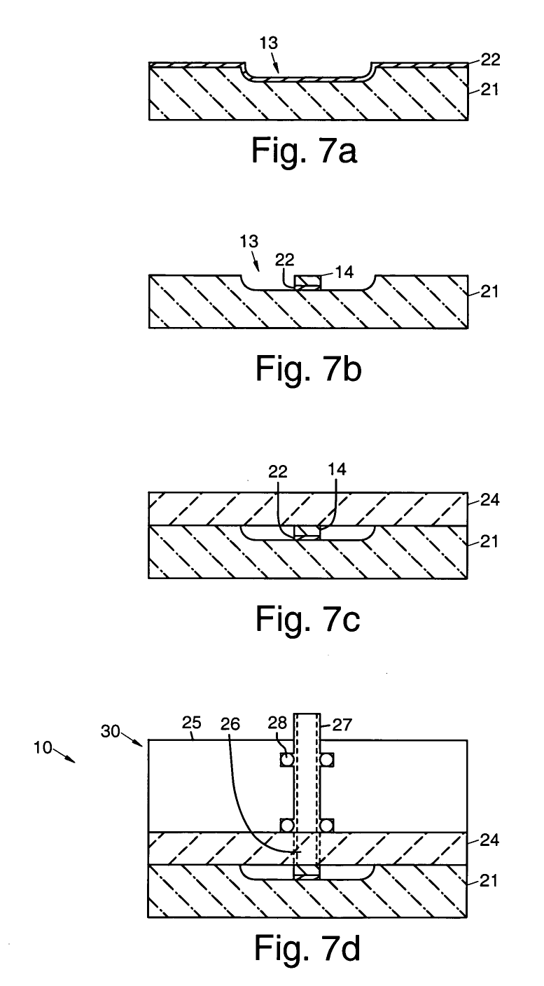

As will be explained in with regard to FIGS. 7a-7d, the ferromagnetic wire 14 may be fabricated with a width of 120 μm instead of 50 μm to improve adhesion between the ferromagnetic wire and glass substrate of the microchannel. In case of the DMC microseparator, 10 the magnetic force on the blood cells 15, 16 in the microchannel 13 dominantly depends on the shape of the wire edge along the microchannel 13 rather than overall cross-section of the ferromagnetic wire 14. Thus, the magnetic forces from a square wire 14 of 50×50 μm² will be same as that from the rectangular wire 14 of 120×50 μm², because the edge shapes of these two wires are the same within the microchannel. It is proven by comparing the simulation magnetic forces of the square wire 14 and of the rectangular wire, FIGS. 6a and 6b.

FIGS. 7a-7d illustrates an exemplary microfabrication process for the magnetophoretic microseparators 10 shown in FIGS. 3a-3c and 4a, for example. The microchannel 13 of the magnetophoretic microseparator 10 is defined by glass-to-glass thermal bonding, between two Borofloat™ glass slides 21, 24. A ferromagnetic nickel wire 14 is fabricated along the length of the microchannel, 13 as shown in FIG. 7b, for example. In the first fabrication step, shown in FIG. 7a, the bottom glass substrate 21 (Borofloat™ glass, 0.7 mm thick, Howard Glass Co., Worchester, Mass.) is etched 50 μm in depth using 25% HF solution. Next, a Ti/Cu/Cr seed layer 22, for nickel electroplating, is evaporated onto the bottom Borofloat™ glass substrate 21, as shown in FIG. 7a. The ferromagnetic wire is fabricated by nickel electroplating, as shown in FIG. 7b. After removing the seed layer 22 using wet chemical etching, the glass chip of the DMC microseparator was completed by glass-to-glass thermal bonding of a top glass layer 24 at 685° C. for 3.5 hrs (FIG. 7c).

While the reduced to practice embodiment used glass for the substrate 21 and top glass layer 24, it is to be understood, however, that these components may be fabricated using silicon wafers or plastic, or combinations of silicon, glass and plastic, for example. In addition, silicon-wafer-to-glass bonding, for example, permits use of a silicon wafer substrate 21 and a top glass layer 24.

As is shown in FIG. 7d, an integrated microfluidic interface (IMI) 30 fabricated by stereolithography may be used to realize a microfluidic interconnect. Nitrile rubber o-rings 26 (size 001-1/2, McMaster-Carr, Atlanta, Ga.) may be used to seal the microfluidic interconnects 30. An ultraviolet (UV) adhesive (1187-M, DYMAX Co., Torrington, Conn.) is dropped into openings in the top glass plate 24 for adhesive bonding on the IMI 30, and capillary forces pull the adhesive into gaps between the IMI 30 and the glass chip (i.e., top glass plate 24). The UV adhesive is cured by placing it under a UV light for about 30 minutes, completing fabrication of the DMC microseparator 10, as shown in FIG. 7d. Finally, to reduce the adhesion of blood cells 15, 16, Pluronic-F108 surfactant (BASF Corp.) was coated onto the surface of the microchannel 13.

The microseparator 10 is designed for use in both the diamagnetic capture mode and the paramagnetic capture mode modes. Preferably, the microchannel 13 is located at the edge of glass chip comprising the magnetophoretic microseparator 10 for the paramagnetic capture mode. As a result, the three outlet channels 12 may be bent away from the edge of the glass chip comprising the magnetophoretic microseparator 10 with careful consideration for fluidic resistance of the three outlet channels 12.

Experimental results are discussed below. An instrument setup for the magnetophoretic microseparator 10 used a permanent magnet used to create an external magnetic field of 0.2 T and a syringe pump was used to drive the fluid. In one test, bovine whole blood diluted to a ratio of 10:1 using phosphate buffered saline (PBS) was prepared as the input blood sample. To measure the effect of the magnetic flux gradient on the red blood cells 15 in the microchannel, fluid flow was stopped.

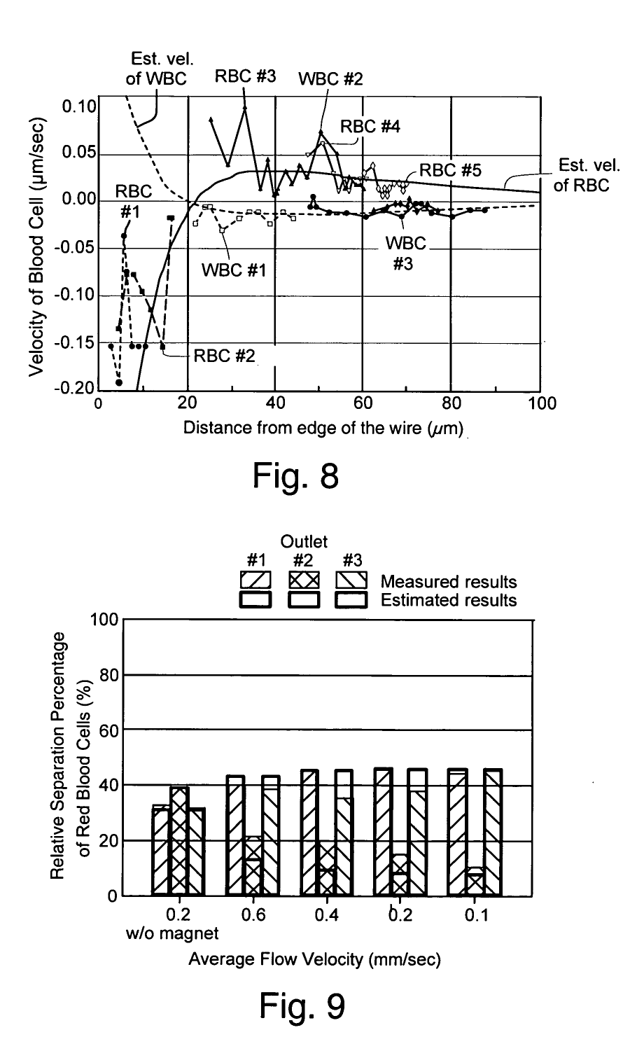

Characterization of the magnetic properties of white blood cells 16 and deoxyhemoglobin red blood cells 15, and the y-direction velocities of the blood cells measured perpendicular to the wire, were measured in the microchannel under stop flow conditions. FIG. 8 shows the measured velocities of white blood cells 16 and deoxyhemoglobin red blood cells 15 versus distance from the edge of the wire. In FIG. 8, positive velocity means that blood cell moves away from the wire 14. In contrast, negative velocity denotes that blood cells moves toward the wire 14. According to our expectation, the deoxyhemoglobin red blood cells 15 in the microchannel of the DMC microseparator 10 are forced away from the wire as paramagnetic particles. On the other hand, the white blood cells 16 are drawn closer to the wire as diamagnetic particles.

The mass density of red blood cells is about 1100 kg/m³ (F. Paul, D. Melville, and S. Roath, “Inviscid approximation trajectories in high gradient magnetic separation,” IEEE Transactions on Magnetics, MAG-18, 792-795, 1982). Therefore, the red blood cells 15 settle to the bottom of the microchannel 13, 50 μm in height, within 1 minute by gravitational forces. Therefore, under the stop flow condition, the magnetic force on the red blood cells 15 (FIG. 6b), located on the bottom of the microchannel, was used for estimating the y-directional velocities of the red blood cells 15. For minimizing the sum of error square between the measured velocities of the red blood cells 15 and the corresponding estimated values, the viscosity of red blood cells 15, η_{RBC}, was fitted to be 5.99×10⁻³ N·s/m². The fitted value of the viscosity was about 6 times larger than the initially estimated values of 0.96×10⁻³ Ns/m². Practically, in the case of red blood cells 15 slowly moving of 0.3 mm/sec through a 39 μm arteriole, Lipowsky (see H. H. Lipowsky, “In Vivo Studies on the Rheological Behavior of Blood Flow in the Microcirculation,” The Rheology of Blood, Blood Vessels and Associated Tissues, D. R. Gross, N. H. C. Hwang, Ed., Ch, 14, Alphen aan den Rijn: The Netherlands, 1981.).reported that the apparent viscosity of red blood cells 15 increases 8 times to about 22×10⁻³ N s/m² in comparison to 3×10⁻³ N·s/m² at 10 mm/sec flow velocity. This inverse relationship between the apparent viscosity and blood cell velocity was presumed to be due to red blood cell aggregation and white blood cells 16 adhesion. In this work, the main reason for increased viscosity of red blood cells 15 was assumed to be friction between the red blood cells 15 and the glass surface on the bottom of the microchannel 13 under stop flow condition.

The diamagnetic property of the white blood cells 16, as shown in FIG. 8, agrees with result reported by Takayasu et al (see M. Takayasu, N. Duske, S. R. Ash, and F. J. Friedlaender, HGMS studies of blood cell behavior in plasma, IEEE Transactions on Magnetics, MAG18, 1520-1522, 1982). However, no literature could be found for the value of magnetic susceptibility of white blood cells 16. Therefore, by using the measured sizes of the white blood cells 16 observed in FIG. 8, and the assumption that the viscosity of the white blood cells 16, η_{WBC}, was 0.96×10⁻³ N·s/m², relative magnetic susceptibilities of these white blood cells 16 in water were fitted to minimize the sum of error square between the measured velocities of these white blood cells 16 and the corresponding theoretical values, as shown in Table 2.

TABLE 2
Sizes and fitted relative magnetic susceptibilities of
the white blood cells (WBCs) 16 observed in FIG. 8 on the
assumption that viscosity, η_{WBC}, of these white blood cells 16 is 0.96 × 10⁻³
N · s/m².

| | WBC #1 | WBC #2 | WBC #3 | Average |
|---|---|---|---|---|
| Measured | 4.9 ± 0.41 | 5.36 ± 0.54 | 7.18 ± 0.42 | 5.81 ± 0.27 |
| diameter, | | | | |
| μm | | | | |
| Fitted relative | −0.217 ± 0.036 | −0.105 ± 0.019 | −0.065 ± 0.008 | −0.129 ± 0.014 |
| magnetic | | | | |
| susceptibility, | | | | |
| 10⁻⁶ (SI) | | | | |

The white blood cells 16 were considered to be settled down on the bottom of the microchannel 13, because the mass density of white blood cells 16 is significantly higher than that of water, 1000 kg/m³. The average relative magnetic susceptibility of the white blood cells 16 was determined to be −0.129×10⁻⁶ (SI) using curve fitting. This value for the magnetic susceptibility of white blood cells 16 was much smaller than that reported for red blood cells 15, −(2.5˜3.5)×10⁻⁶(SI). Under stop flow condition, the friction effect between the white blood cells 16 and the glass surface on the bottom of the microchannel 13 is the primary reason for lower relative magnetic susceptibility of white blood cells 16 on the assumption that the viscosity of white blood cells 16 was 0.96×10⁻³ N·s/m².

As a result, in the DMC microseparator 10, the velocity of red blood cells 15 moving away from the wire 14 is faster than that of the white blood cells 16 moving towards the wire 13, as shown in FIG. 8. Therefore, the magnetophoretic separation efficiency of the red blood cells 15 in the DMC microseparator will be better than that of the white blood cells 16.

FIG. 9 is a chart showing the measured and estimated relative separation percentage of red blood cells 15 at each outlet of the DMC microseparator for various average flow velocities. From FIG. 9, the difference between estimated and measured relative separation percentage of red blood cells 15 from the outlet #2 was 2.4% to 8.9%. There were two main reasons for this difference. The first reason was the friction effect between the red blood cells 15 and the glass surface on the bottom of the microchannel 13, as mentioned in the above section. The friction effect may explain that the measured relative separation percentage of red blood cells 15 was generally lower than the estimated result, as shown in FIG. 9. The second reason was that flow velocity of the red blood cells 15 in the middle of the microchannel 13 was faster than that at a surface of the microchannel. Thus, travel time of the red blood cells 15 at the middle of the microchannel 13 was shorter than the travel time given from an average flow velocity, resulting in decreased separation efficiency. The red blood cells 15 travel time at the surface of the microchannel 13 were longer than the travel time given from the average flow velocity, thereby rather increasing the separation efficiency. As the travel time of the red blood cells 15 passing through the microchannel increases, more red blood cells 15 will settle down on the bottom of the microchannel 13. Therefore, the latter effect becomes dominant at lower flow velocities. The second reason may explain why the difference between the estimated and measured relative separation percentage of red blood cells 15 from the outlet #2 increased from 2.4% to 8.9% for flow velocities of 0.1 mm/sec and 0.6 mm/sec, respectively.

FIG. 10 is a chart showing the measured and estimated relative separation percentage of white blood cells 16 at each outlet of the DMC microseparator for various average flow velocities. By counting white blood cells 16 through a microscope (ME600, Nikon Instruments, Inc., Melville, N.Y.) with a fluorescent detector (Y-FL, Nikon Instruments, Inc.), the relative separation percentage of white blood cells 16 at each outlet 12 was measured for varying flowing velocities from 0.05 mm/sec to 0.6 mm/sec, as shown in FIG. 10. The average and standard deviation were calculated from three measured data sets. The experimental results show that the DMC microseparator 10 separates out 72.7% of the white blood cells 16 from the outlet #2 at 0.05 mm/sec flow velocity. The relative separation percentage was approximately equal for flow velocities greater than 0.2 mm/sec. As mentioned above, white blood cells 16 may have either higher viscosity or lower magnetic susceptibility than red blood cells 15. Therefore, the relative separation percentage of white blood cells 16 will be lower than that of red blood cells 15 at a same flow velocity. This explains why white blood cells 16 show lower separation efficiency at flow velocities greater than 0.2 mm/sec.

To estimate the relative separation percentage of white blood cells 16, the viscosity of the white blood cells 16, η_{WBC}, and average radius of the white blood cells 16, b, were assumed to be 0.96×10³ N·s/m² and 5 μm (see E. Kelemen, Ed. Physiopathology and Therapy of Human Blood Diseases (International series of monographs in pure and applied biology. Division: Modern trends in physiological sciences, vol. 30); Pergamon Press Ltd.: Oxford, 1969). Under these assumptions, the relative magnetic susceptibility of the white blood cells 16, Δχ_{WBC}, was fitted to −0.234×10⁻⁶(SI), which makes an estimated relative separation percentage of white blood cells 16 equal to the measured value of 72.7% from the outlet #2 at 0.05 mm/sec flow velocity. The estimated relative separation percentage of the white blood cells 16 was numerically calculated, as shown in FIG. 10.

FIG. 10 shows that difference between the estimated and measured relative separation percentage of the white blood cells 16 from the outlet #2 increased to 15.4% as flow velocity increases to 0.6 mm/sec. This is exactly same phenomenon that was occurred in the case of the red blood cells 15. Therefore, the second reason mentioned above with regard to FIG. 9, that explains why the difference between estimated and measured relative separation percentage of the red blood cells 15 increased as flow velocity increased, could also be applied to the case of the white blood cells 16.

In a test of another reduced to practice embodiment of the microseparator 10 operated in diamagnetic capture mode, bovine whole blood was diluted to a ratio of 1:10 using a 3 mM isotonic sodium hydrosulfite solution. Red blood cells 15 flowed at average velocities of 0.1 mm/sec and 0.2 mm/sec through the microchannel of the diamagnetic capture mode microseparator 10 with an external magnetic flux of 0.2 T using a permanent magnet. Red blood cells 15 flowed at average velocity of 0.2 mm/sec without the external magnetic flux. Red blood cells 15 are forced away from the wire with the application of an external magnetic field. The measured relative percentage of red blood cells 15 at each outlet channel 12 shows that the diamagnetic capture mode microseparator 10 separates out 89.7% of red blood cells 15 from whole blood at a 0.1 mm/sec average flow velocity.

In a test of another reduced to practice embodiment of the microseparator 10 was performed in paramagnetic capture mode. In this test, red blood cells 15 flowed at average velocities of 0.1 mm/sec and 0.2 mm/sec through the microchannel 13 of the paramagnetic capture mode microseparator 10 with a 0.2 T external magnetic flux. Red blood cells flowed at average velocity of 0.2 mm/sec without the external magnetic flux. Red blood cells 15 are drawn closer to the wire 13 with the application of an external magnetic field. The measured relative percentage of red blood cells 15 at each outlet channel 12 on a three-stage cascade paramagnetic capture mode microseparator 10 showed that 93.5% of red blood cells 15 is separated out from whole blood at a 0.1 mm/sec average flow velocity. White blood cells 16 flowed at average velocity of 0.05 mm/sec with the external magnetic flux. The measured relative percentage of white blood cells 16 at each outlet channel 12 showed that a three-stage cascade paramagnetic capture mode microseparator 10 (FIG. 4a) separates out 97.4% of white blood cells 16 from whole blood at a 0.05 mm/sec average flow velocity. Experimental results show that magnetophoretic microseparators 10 fabricated using microfabrication technology moves red blood cells 15 in a manner consistent with simulation results. The experimental results demonstrated the superiority of the magnetophoretic microseparators 10 to a conventional magnetophoretic macroseparator (Takayasu et al.), which has a channel length of 3.6 m, a separation time from 5 min to 10 min, and uses a magnetic flux of 2.0 T. From the distribution of red blood cells in the microchannel 13, it was observed that in the microseparator 10 designed for the diamagnetic capture mode, the red blood cells 15 were forced away from the wire 13. This distribution also showed that for red blood cells 15 that were on the bottom surface of the microchannel 13, the magnetic force on a red blood cell 15 becomes significant at distances greater than 27 μm from the wire 13, which was in good agreement with theoretical results.

Experimental results regarding reduced to practice embodiments also show that the diamagnetic capture mode microseparator 10 separated out 89.7% of the red blood cells 15 from outer outlet channels 12a, 12c at 0.1 mm/sec flow velocity. By monitoring white blood cells 16 probed with a fluorescence dye, it was observed that 72.7% of white blood cells 16 were separated into the center outlet channel 12b at 0.05 mm/sec flow velocity. The three-stage cascade paramagnetic capture mode microseparator 10 separated out 93.5% of the red blood cells 15 from the center outlet channels 12b at 0.1 mm/sec average flow velocity. By monitoring white blood cells 16 probed with a fluorescence dye, it was observed that 97.4% of white blood cells 16 were separated into the outer outlet channels 12a, 12c at 0.05 mm/sec average flow velocity. Consequently, the magnetophoretic microseparator 10 both diamagnetic capture mode and paramagnetic capture mode extracted highly concentrated white blood cells 16 from whole blood.

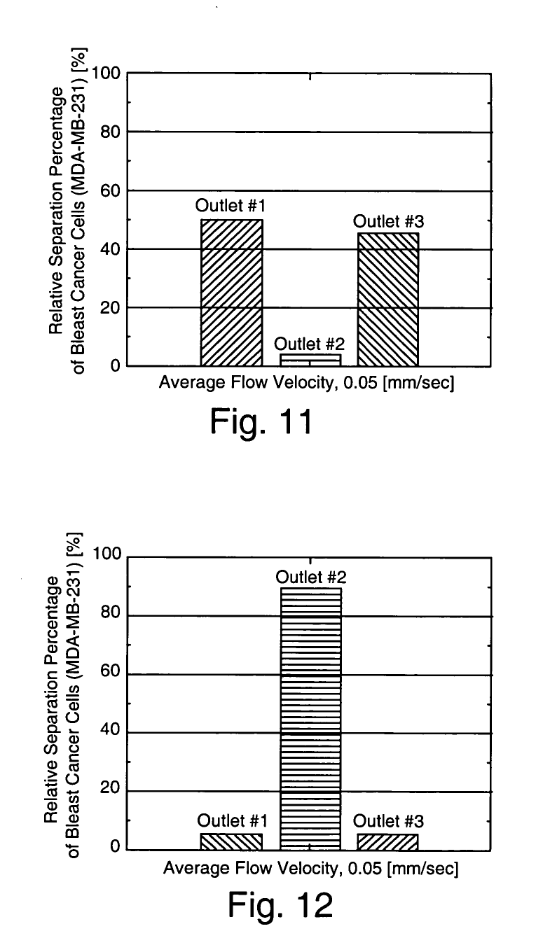

In a test of another reduced to practice embodiment of the microseparator 10 was performed in diamagnetic and paramagnetic capture mode. In this test, blood cells with breast cancer cells (MDA-MB-231) flowed at an average velocity of 0.05 mm/sec through the microchannel 13 of the diamagnetic and paramagnetic capture mode microseparator 10 with a 0.2 T external magnetic flux. In the diamagnetic capture mode microseparator, red blood cells 15 are forced away from the wire 13 with the application of an external magnetic field, and breast cancer cells are drawn closer to the wire 13, as shown in FIG. 11. The measured relative percentage of breast cancer cells at each outlet channel 12 on a diamagnetic capture mode microseparator 10 showed that 89.36% of breast cancer cells 15 is separated out from whole blood at a 0.05 mm/sec average flow velocity. While, in the paramagnetic capture mode microseparator, red blood cells 15 are drawn closer to the wire 13 with the application of an external magnetic field, and breast cancer cells are forced away from the wire 13, as shown in FIG. 12. The measured relative percentage of breast cancer cells at each outlet channel 12 on a paramagnetic capture mode microseparator 10 showed that 95.86% of breast cancer cells 15 is separated out from whole blood at a 0.05 mm/sec average flow velocity.

While the microseparator 10 has been disclosed with multiple outlet channels, a single channel 12 can be employed. In the case of a single outlet channel 12, separation of suspended cells 16 in blood can be achieved using the laminar fluid flow characteristics of he microchannel

Thus, blood separation systems embodied in a micro device format and fabrication methods have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. Magnetophoretic blood separation apparatus for separating suspended cells in blood, comprising:
a microchannel having at least one inlet channel disposed at an inlet end and at least one outlet channel disposed at an outlet end; and
a ferromagnetic wire disposed a predetermined distance between the at least one inlet channel and the at least one outlet channel and defining walls of the microchannel through which blood containing suspended cells can flow between the inlet channel and the at least one outlet channel; and
an external magnetic for applying a magnetic field in a predetermined direction relative to the microchannel so as to induce a high gradient magnetic field near the ferromagnetic wire;
wherein red blood cells are forced in one direction relative to the wire and the suspended cells are forced in a direction opposite to the direction of the red blood cells, and are separated without the use of magnetic tagging or inducing materials.

2. The apparatus recited in claim 1 wherein the magnetic field is applied in a direction normal to a plane defining the microchannel so as to provide diamagnetic capture mode blood separation apparatus.

3. The apparatus recited in claim 1 wherein the magnetic field is applied in a direction orthogonal to a plane defining the microchannel so as to provide paramagnetic capture mode blood separation apparatus.

4. The apparatus recited in claim 1 wherein the microchannel comprises surfactant on its inner surface.

5. The apparatus recited in claim 1 wherein the ferromagnetic wire is disposed between top and bottom glass substrates.

6. The apparatus recited in claim 1 wherein the ferromagnetic wire comprises:
first and second ferromagnetic wires disposed along the microchannel a predetermined distance between the at least one inlet channels and the at least one outlet channel that define at least a portions of outer walls of the microchannel.

7. The apparatus recited in claim 1 wherein the at least one inlet channel comprises a plurality of inlet channels.

8. The apparatus recited in claim 1 wherein the at least one outlet channel comprise left, center and right outlet channels.

9. The apparatus recited in claim 1 wherein the ferromagnetic wire comprises:
a first ferromagnetic wire disposed along the microchannel a predetermined distance between the at least one inlet channels and the at least one outlet channel and separated from lateral walls of the microchannel to define blood flow channels through which blood containing suspended cells can flow between the at least one inlet and outlet channels; and
a plurality of sets of additional ferromagnetic wires disposed along the microchannel between the first ferromagnetic wire and the at least one outlet channel which set are laterally separated from each other and from the lateral walls of the microchannel to allow passage of blood therearound, wherein the ferromagnetic wires of each set are separated from each other to allow passage of blood therebetween.

10. The apparatus recited in claim 9 wherein the at least one inlet channel comprises a plurality of inlet channels.

11. A method of fabricating a magnetophoretic microseparator, comprising:
providing a substrate;
forming a microchannel in the substrate;
fabricating a ferromagnetic wire on the etched substrate; and
bonding a top layer to the substrate to encase the ferromagnetic wire and complete the magnetophoretic microseparator.

12. The method recited in claim 11 wherein the microchannel is formed having at least one inlet channel disposed at an inlet end and at least one outlet channel disposed at an outlet end.

13. The method recited in claim 110 wherein the substrate is etched to form the microchannel.

14. The method recited in claim 11 wherein the ferromagnetic wire is fabricated by:
depositing a seed layer on the etched substrate;
depositing a ferromagnetic wire on the seed layer; and
removing the seed layer except under the ferromagnetic wire.

15. The method recited in claim 11 further comprising depositing surfactant on a surface of the microchannel.

16. The method recited in claim 11 further comprising coupling a microfluidic interface to the magnetophoretic microseparator.

17. The method recited in claim 11 wherein the top layer is thermally bonded to the substrate.

18. The method recited in claim 12 wherein the at least one inlet channel comprises a plurality of inlet channels.
